(19) United States
(12) Patent Application Publication
(10) Pub. No.: US 2006/0096215 A1
(43) Pub. Date: May 11, 2006

(54) Muntin bar clip with tip tabs received into ink marked slits in spacing means

(76) Inventor: Gerald G. Gieseke, Selah, WA (US)

Correspondence Address: LIEBLER, IVEY, CONNOR, BERRY & ST. HILAIRE;The Edison Professional Building, 1141 North Edison, Suite C, P.O. Box 6125, Kennewick, WA, 99336-0125, US

(21) Appl. No.: 10/982,657

(22) Filed: Nov. 5, 2004

(51) Int. Cl. E06B 3/70

(52) U.S. Cl. 52/456

(57) ABSTRACT

An apparatus of an muntin bar clip having downwardly projecting tip tabs at the tip which are received into slits formed in spacing means in the manufacture of sealed multi-pane windows.

### FIELD OF THE INVENTION

The present invention relates generally to an apparatus of a muntin bar clip to secure the position of muntin bars during and following the fabrication of multi-pane sealed glass window units. The disclosure relates to securing and positioning muntin bars at multi-pane sealed glass window unit perimeters and in joining hollow false muntin bars within such units. The invention relates particularly to muntin bar clips intended to fix the position of hollow false muntin bars at the perimeter of the window unit utilizing the sealing methods including foam strips and/or butyl as the sealing medium. The disclosed invention more particularly relates to muntin bar clips for the purpose of fixing the position of hollow false muntin bars at the perimeter of the window unit where the false muntin bar is other than orthogonal in relation to the perimeter of the window. The invention more specifically provides the fixing of the position of muntin bars in addition to lessening the likelihood of either breaking or cracking the glass panes, as multi-pane sealed unit assembly occurs, or of causing seal failure of such units either during manufacture or following installation.

### BACKGROUND OF THE INVENTION

Sealed multi-pane sealed window units have become standard for new and renovation construction within industrialized nations. Architectural detail is provided by the fixing of false muntin bars between panes of glass within such units. Such detail frequently requires multiple false muntin bars to intersect to form distinct patterns within the unit. The positioning of muntin bars commonly results in muntin bar ends intersecting with the perimeter of a window unit in other than an orthogonal relationship between the muntin bar and the unit perimeter forming, for example, a sunburst or radiating pattern. The securing of muntin bars in place during and following manufacture is critical in that any shifting from proper alignment will result in an unacceptable appearance. The method of or apparatus securing muntin bars, at the perimeter of such units, must not interfere with the sealing method of the unit. A method of fixing the position of muntin bars at a window unit perimeter has included the fixing of a pin at the muntin bar end with the pin to be received into a hole prepared in the window unit perimeter at the frame. The pin and hole combination required additional manufacturing steps and, in the case of sealed units, created potential sealant breaches.

The advent of new manufacturing techniques and the production of foam strip sealed and butyl sealed inert gas filled window units renders problematic or unusable methods or apparatus, for the positioning of muntin bars, disclosed in the prior art. Maintenance of gas integrity within such units is of paramount importance in insuring continued heat exchange properties and eliminating the potential for formation of condensation within the interior of the unit. Existing prior art is unlikely to provide for the maintenance of such characteristics with a substantial likelihood that the interior of sealed units will experience a breach of the seal. The apparatus disclosed herein is principally adapted for use with foam strip, butyl and other similar pliable or flexible seal systems including SUPER SPACER®.

Prior art which is distinguished includes the following which, along with additional patents, disclosed in an information disclosure statement, include Pat. Nos. 6,494,002 and 6,131,356 to Gieseke which disclose muntin bar clips with tip 43 terminating in a blunt end 50 and alternatively one or more prongs 45. Prior art also includes Patent 3,686,814 to Anderson; Patent 4,644,721 to Bloomquist et al.; Pat. No. 4,890,435 to Wilkening et al.; Pat. No. 4,060,950 to Rackard et al.; Pat. No. 3,108,336 to Tate; Pat. No. 5,154,034 to Stanek; Pat. No. 3,791,095 to Martin; Pat. No. 5,678,376 to Poma; Pat. No. 5,325,579 to Baier; Pat. No. 4,437,284 to Cribben et al.; Pat. No. 3,307,316 to Gray; Pat. No. 4,989,384 to Kinghorn et al.; Pat. No. 3,645,058 to Jacobson; Pat. No. 3,340,661 to Krieger; Pat. No. 4,949,521 to Riegelman et al.; Pat. No. 4,970,840 to Ouellette et al.; Pat. No. 3,099,865 to Burnett; Pat. No. 5,363,625 to Philippi; Pat. Nos. 5,313,761 and 5,678,377 to Leopold; Pat. No. 5,048,252 to Osborn; Pat. No. 3,293,817 to MacGregor; The patents referred to herein are provided herewith in an Information Disclosure Statement in accordance with 37 CFR 1.97.

### SUMMARY OF THE INVENTION

The muntin bar clips of Pat. Nos. 6,494,002 and 6,131,356 to Gieseke disclosed a muntin bar clip having a post, which is received into and friction secured into a hollow muntin, and a tip, distal from the post, terminating in a tip end formed as either a blunt end or prongs which rely on friction securing of the muntin clip tip end between a pane and spacer material and or sealing means and/or the structure of one or a plurality of spikes formed at the muntin bar clip tip end at the blunt end or prongs providing a penetration of the one or a plurality of spikes into the spacer material and or sealing means. The disclosure of this invention, as an improvement over Pat. Nos. 6,494,002 and 6,131,356 to Gieseke, is the formation of a tab at the muntin clip tip blunt end wherein the tab is received into a slit or cut in the spacer material including a slit or cut formed by slit or cut forming means in a SUPER SPACER® and the blunt end is received intermediate the pane and the spacer or spacing means which includes foams, butyl, SUPER SPACER® and other sealing means known to those of ordinary skill in the art. An alternative form may have at least one spike formed at the blunt end for insertion into the spacing means.

The improved muntin bar clip disclosed herein is directed particularly to use with the multi-pane sealed unit. Several sealing methods or sealing means in the prior art, as discussed in Pat. Nos. 6,494,002 and 6,131,356 to Gieseke, are recognized within the industry. These generally employ a spacing means, which serves a sealing function in addition to insuring correct spacing between panes, and an additional sealing means at the window perimeter. Spacing and sealing means includes the use of a solid butyl strip spaced between panes with a metal strip; the butyl strip used in this process is known as a swiggle strip. Another method of sealing multi-pane sealed window units is the use of an inner foam strip having an outer butyl seal; this method may be known as a SUPER SPACER®. The foam strip of the SUPER SPACER® is generally a butyl or plastic spacer which separates glass panes in the multi-pane sealed unit. Used with the SUPER SPACER®, as a final sealing medium, is an outer butyl seal in contact with each pane and the plastic strip, completing the sealing function. Other spacing and sealing techniques are known to those in the window arts which will find the present invention to have utility. The multi-pane construction is accomplished with the intent of 1) providing a sealed unit capable of maintaining the sealed integrity during manufacture through shipping, installation and finally use over the years following installation and 2) insuring that muntin bars remain positioned as at the time of manufacture. The tip tab of this improvement invention is principally anticipated to be inserted or forced or received into a slit or cut in the spacing means. Whatever the spacing and sealing means utilized, the muntin bar tip end blunt end, of this improvement, will be received between the pane and said spacing/sealing means and the tip tab will be received into the cut or slit in the spacing means to thus anchor into position the muntin bar clip tip end.

Multi-pane construction generally includes positioning of muntin bars, between window panes, for architectural detail. Hollow false muntin bars facilitate the formation of patterns desired by the consumer. Muntin bars are interconnected within the unit, for pattern formation, and positioned at the edge of the window unit with muntin bar clips. The post of a muntin bar clip is received into the hollow muntin bar end which is either to be joined with other muntin bars for pattern formation or which is to be positioned at the window edge. Where pattern formation is to be achieved the muntin bar clip may have a plurality of posts interconnected with a swivel means. Where a muntin bar is to be positioned at a window unit perimeter the muntin bar clip will have a tip having a tip end, distal from the post, which is received between a pane and the spacing means, including a spacing structure and/or sealing structure, separating panes in the multi-pane sealed window unit at the perimeter. The tip end of this disclosure is distinguished from that of Pat. Nos. 6,494,002 and 6,131,356 to Gieseke where the tip end terminated in a blunt end or prongs and the tip end was received into the spacer or between the pane and spacer. In this disclosure the tip end of the muntin bar clip is received between the spacing means, composed generally of a firm butyl or plastic strip and composed, in the preferred embodiment of a SUPER SPACER®, and the pane and the tip tab, formed at the blunt end, is received into the cut or slit formed by cut or slit forming means in the spacing means. The tip tab at the blunt end of this disclosure is distinguished by the formation, by means including a stamping or metal forming process, of at least one or a plurality of tip tabs formed at the blunt end. The one or a plurality of tip tabs may be formed with any shape and dimension capable of being forced into the cut or slit in the spacing means but is, in the preferred embodiment, generally cut or stamped in a rectangular shape. The at least one tip tab is generally orthogonal to the plane of the blunt end directed toward the post generally parallel to the orthogonal to the offset. The metal forming means will make the appropriate cuts, will force the resulting tab, denoted here as one or a plurality of tip tabs, to bend into the desired position leaving a portion of the blunt end intact at the tip end or blunt end. The tip end, at the blunt end, will be received between the pane and the spacing means such that the at least one tip tab will be received into the cut or slit means at the spacing means.

In an alternative embodiment the tip end, at the blunt end, will form at least one tip tab and at least one spike where the at least one spike will penetrate the spacing means.

In an additional embodiment an offset 30, formed intermediate the tip 40 and the fastener means 20, is generally parallel to the spacing means. The offset 30 forms a shelf having a first side 31 and a second side 32 and a mid point 33. In this embodiment, by metal forming means, the first side 31 is bent downwardly proximal the mid point 33. In an alternative embodiment both the first side 31 and the second side 32, by metal forming means, are bent downwardly each proximal the mid point 33 forming tabs capable of being received into a cut or slit 100 in a spacing means 84.

A spacing means, such as SUPER SPACER®, is applied at a perimeter of a pane. The spacing means application means indexes and cuts or slits the spacing means as required for the installation of muntin bars and muntin bar clips having tabs. Muntin bar grids are assembled and placed, by a workman, in contact with the spacing means such that the muntin clip tabs or tip tabs are proximal the cut or slit. The location of the cut or slit is frequently difficult to detect by visual inspection as the workman positions the muntin bar grid. The marking of the cut or slit by a dot or line of printer ink facilitates the visual location of the cut or slit and expedites the installation of the tab or tip tab by the workman. A dot or line of printer ink is applied by the addition of a cartridge receptacle receiving a printer head where said printer head is controlled by printer computer program means received into a computer or controller having memory wherein said printer computer program means causes the printer head to apply a line or dot of printer ink as the spacing means application means indexes to the place where a cut or slit is formed in the spacing means by the spacing means application means.

### BRIEF DESCRIPTION OF THE DRAWINGS

The foregoing and other features and advantages of the present invention will become more readily appreciated as the same become better understood by reference to the following detailed description of the preferred embodiment of the invention when taken in conjunction with the accompanying drawings, wherein:

FIG. 1 is a perspective showing an embodiment of a muntin bar clip 1 with a post 10, a post end 13 with post end bevels 14 and a post surface 15 having a first and second side 16, 17; a fastener means 20, a tip 40 having a tip end 43 distal from the post end 13 terminating in a blunt end 50 having a blunt end first side 51, a blunt end second side 52 and a blunt end midpoint 53 intermediate the said blunt end first side 51 and blunt end second side 52. The blunt end 50 at the blunt end first side 51 or at the blunt end second side 52 is bent, by metal forming means, to form a tip tab 50′ orthogonal to an offset 30 which is formed intermediate the tip 40 and the fastener means 20. The tip tab 50′ projects toward the post 10.

FIG. 1A illustrates an alternative embodiment of the tip 40 wherein the offset 30, formed intermediate the tip 40 and the fastener means 20 and generally parallel to the spacing means, forms a shelf having a first side 31 and a second side 32 and a mid point 33 intermediate said first side 31 and said second side 32. In this embodiment, by metal forming means, the first side 31 is bent downwardly proximal the mid point 33. In an alternative embodiment both the first side 31 and the second side 32, by metal forming means, are bent downwardly each proximal the mid point 33 forming tabs capable of being received into a cut or slit 100 in a spacing means 84.

FIG. 2 is a perspective of an alternative embodiment of a muntin bar clip 1 with a post 10; a fastener means 20, a post second end 13 distal from the post end 13; a tip 40 having a tip end 43 distal from the post end 13 terminating in a blunt end 50 wherein a blunt end first side 51 and or a blunt end second side 53 is bent, by metal forming means, to form a tip tab 50′ or a tip tab 50″ orthogonal to the offset 30 and wherein said tip tab 50′ and or 50″ projects toward the post 10. Also illustrated is the option of forming, at the blunt end 50, one or a plurality of spikes 44 generally orthogonal to the plane of the blunt end 45 and parallel to the offset 30; the tip 40 has a tip second end 43 distal from the tip end 43; the one or a plurality of spikes 44 project toward the tip second end 43. Illustrated is the stamping aperture 47 formed when the one or a plurality of spikes 44 is bent into position. Rotatable connecting means 35 connecting the post 10 and the tip 40 at the post second end 13 and the tip second end 43 such that the post 10 and the tip 40 are rotatably secured by the connecting means which provides a swivel function.

FIG. 2A , 2B and 2C are, respectively, a side elevation, a top plan and a front elevation of the muntin bar clip tip 40 from tip end 43 to tip second end 43′. Illustrated is the tip second end 43, offset 30, blunt end 50 and tip tab 50′. The depiction in these drawings reveal a typical means of forming the one or a plurality of tip tabs 50′ by a stamping process forming cuts followed by bending the resulting tab to be generally orthogonal to the plane of the blunt end 50 and to the offset 30 and directed toward the post 10.

FIG. 3 is section from a side elevation showing a multi-pane sealed window unit 70 having panes 71, a perimeter 72 and a hollow false muntin bar 65, shown in elevation section, having an aperture 66 and end 68; a muntin bar clip 1 with a post 10, a post end 13; a fastener means 20; a tip 40 having a tip end 43 distal from the post end 13 terminating in a blunt end 50 with illustrated one or a plurality of tip tabs 50′. Also shown is the sealing structure 80 composed of butyl 82, and spacing means composed of a foam strip depicted as a SUPER SPACER® 84. The blunt end 50 is shown positioned between the pane 71 and super spacer 43 at the perimeter 72. The one or a plurality of tip tabs 50′ are shown penetrating the SUPER SPACER® 84 at an indexed cut or slit 100 in the spacing means 84.

FIG. 4 is side elevation showing a muntin bar clip 1 with a post 10, a post end 13; a fastener means 20; a tip 40 having a tip end 43 distal from the post end 13 terminating in a blunt end 50 with illustrated one or a plurality of tip tabs 50′; an offset 30 formed intermediate the tip 40 and the fastener means 20.

FIG. 5 is a perspective of an alternative embodiment of that shown in FIG. 2 wherein the muntin bar clip 2 has a plurality of posts 10, 10′.

FIG. 6 is an elevation section showing the muntin bar clip 1 received into a false muntin bar 65 wherein the blunt end 50 is received between a pane and a spacing means 84. Depicted is a cut or slit 100 which receives a tip tab 50′.

FIG. 7 is a detail from FIG. 6 showing an exploded view of the muntin bar clip 1 with tip tab 50′ and spacing means 84 having a cut or slit 100 to receive the tip tab 50′. Also illustrated is at least one dot of printer ink 150 highlighting the cut or slit 100 in the spacing means 84.

FIG. 8 is a detail from FIG. 7 showing a spacing means 84 with a cut or slit 100 marked with a line of printer ink 150.

FIG. 9 and FIG. 10 show a detail from FIG. 7 and a detail from FIG. 9 illustrating an alternative embodiment wherein a plurality of tip tabs 50′ and 50″ are formed at the blunt end 50.

FIG. 11 is a detail from FIG. 10 illustrating an embodiment of the tip tab 50′ wherein the blunt end 50, intermediate the blunt end first side 51 and the blunt end second side 52, is formed by metal forming means into at least one tip tab 50′.

FIG. 12 illustrates the ink marking 150 of slits 100 formed by spacing means application means which indexes and cuts or slits 100 into spacing means 84 as required for the installation of muntin bars and muntin bar clips having at least one tip tab 50′; the ink marking 150 of the slit 100 is by a dot or line of printer ink 150 applied by the addition of a cartridge receptacle means receiving a printer head 200 where said printer head 200 is controlled by printer computer program means 190 received into a computer 192 or controller having memory 194 wherein said printer computer program means 190 causes a printer control unit 196 to actuate a printer head drive unit means 198 causing printer head 200 to apply a line or dot of printer ink 150 as the spacing means application means indexes to the location in the spacing means 84 where a slit 100 is formed in the spacing means 84 by the spacing means application means.

### DETAILED DESCRIPTION

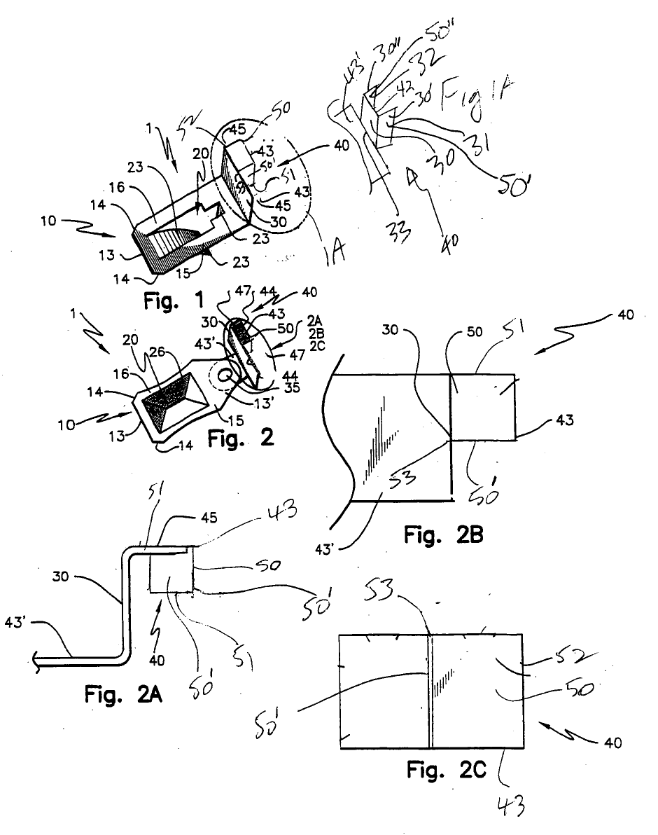

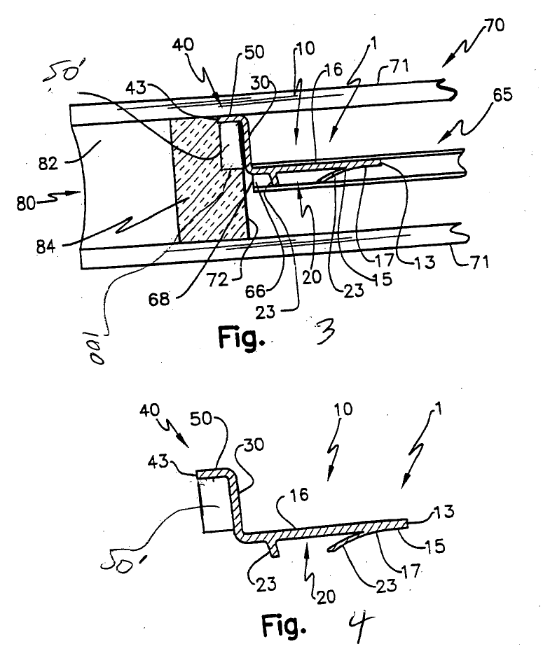

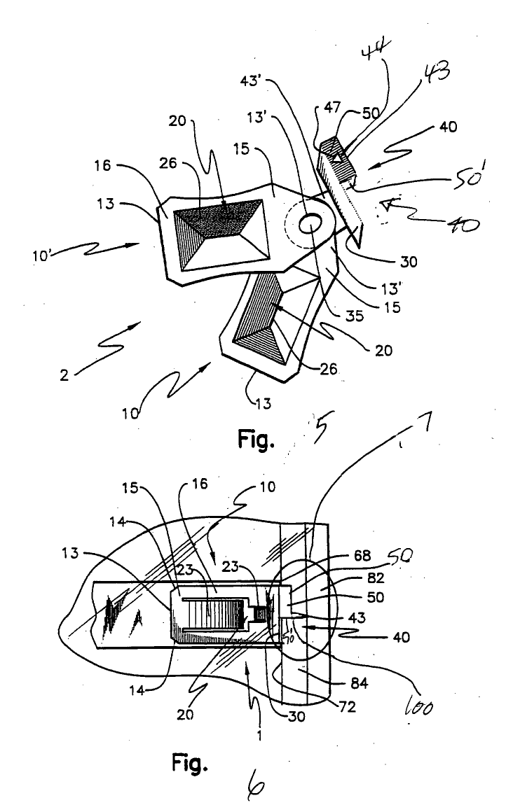

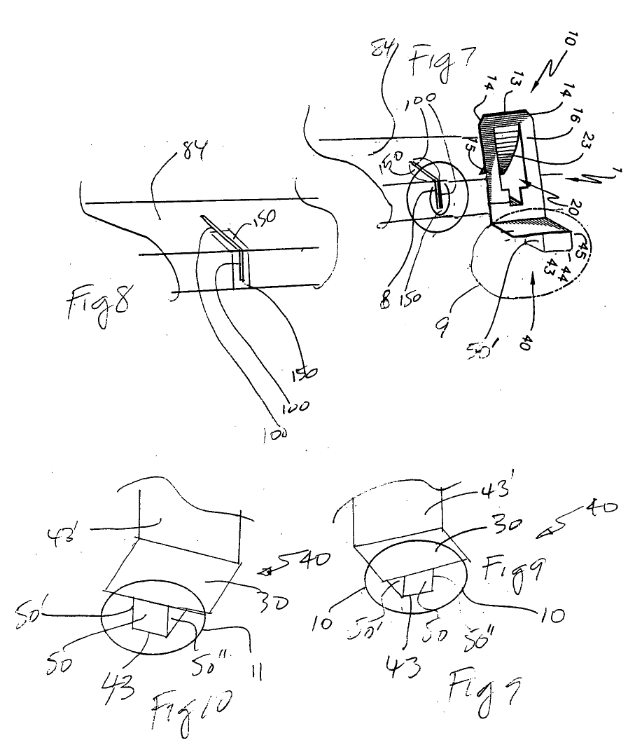

The preferred embodiment of the present invention seen in FIG. 1 through 7 and 9 through 11, is formed generally by a stamping means of a tip 40 terminating in a blunt end 50 wherein one or a plurality of tip tabs 50′ are formed, by stamping or forming means including metal forming, at the blunt end 50; the one or a plurality of tip tabs 50′ and or 50″ and, where desired, one or a plurality of spikes 44, project toward the post 10. Stamping apertures 47 are formed when the one or a plurality of spikes 44 are formed and bent into position. The tip end 43, generally formed from sheet metal, is dimensioned to provide material strength sufficient to maintain the position of the hollow false muntin bar 65 relative to the perimeter 72 while of a thickness which will not cause breaking of the pane 71 or create a sealing structure 80 leak. In the preferred embodiment the tip end 43 is formed with a blunt end 50 with at least one tip tabs 50′ or 50″. The blunt end 50 is received between the sealing structure and the pane 71, for example in the instance of a sealing systems such as the swiggle strip or SUPER SPACER®, between the sealing structure and the pane 71 and the at least one tip tab 50′ is received into a cut or slit 100 formed by slit forming means in the spacing means 84. The tip end 43 with at least one tip tab 50′ reduces the area of a tip end 43 to be inserted between the sealing structure and the pane 71, thus reducing the potential for breaking or cracking the glass or violation of the seal either during manufacture or during any subsequent phase of the life of a multi-pane unit.

An alternative embodiment of the invention disclosed herein is shown at FIG. 1A wherein the offset 30, formed intermediate the tip 40 and the fastener means 20 and generally parallel to the spacing means, forms a shelf having a first side 31 and a second side 32 and a mid point 33 intermediate said first side 31 and said second side 32. In this embodiment, by metal forming means, the first side 31 is bent downwardly proximal the mid point 33. In an alternative embodiment both the first side 31 and the second side 32, by metal forming means, are bent downwardly each proximal the mid point 33 forming tabs capable of being received into a cut or slit 100 in a spacing means 84.

Additional embodiments of the disclosure are shown at FIGS. 9, 10 and 11 wherein the blunt end 50 is formed, by metal forming means, to present at least one tip tab 50′. In FIGS. 9 and 10 the blunt end first side 51 and the blunt end second side 52 are formed, by metal forming means, to be bent backward toward the post 10 forming tip tabs 50′ and 50″. In FIG. 11 the blunt end 50, intermediate the blunt end first side 51 and the blunt end second side 52 and proximal the blunt end midpoint 53, is formed by metal forming means into at least one tip tab 50′ projecting backward toward the post 10 and projecting downwardly to be received into a slit 100.

The muntin bar clip 1 may be formed from a material capable of formation by stamping or cutting including, for example, sheet metal, plastics, composite materials

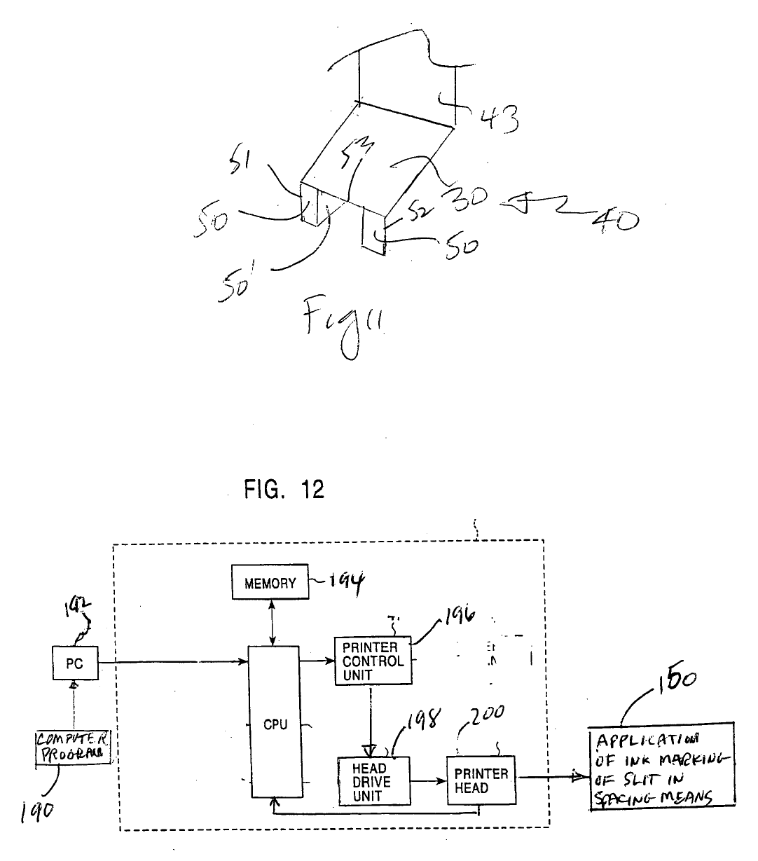

FIG. 12 illustrates the ink marking 150 of slits 100 formed by spacing means application means which indexes and cuts or slits 100 into spacing means 84 as required for the installation of muntin bars and muntin bar clips having at least one tip tab 50′; the ink marking 150 of the slit 100 is by a dot or line of printer ink 150 applied by the addition of a cartridge receptacle means receiving a printer head 200 where said printer head 200 is controlled by printer computer program means 190 received into a computer 192 or controller having memory 194 wherein said printer computer program means 190 causes a printer control unit 196 to actuate a printer head drive unit means 198 causing printer head 200 to apply a line or dot of printer ink 150 as the spacing means application means indexes to the location in the spacing means 84 where a slit 100 is formed in the spacing means 84 by the spacing means application means.

An additional embodiment of the invention comprises the formation of at least one downward projecting tip tab marked as 30′, 30″, 50′and 50″, orthogonal to the post 10 by metal forming means at an offset 30 or at a blunt end 50. Formation at the offset 30, shown in FIG. 1A, may be by cutting and bending means of an offset 30 first side 31 and/or second side 32 from the first side 31 and/or second side 32 most distal from an offset midpoint 33 to a point intermediate the first side 31 and/or second side 32 and the midpoint 33 to form at least one tip tab 50′ downwardly extending from the offset 30 and extending orthogonal to the post 10 to be received into a slit 100 formed in a spacing means 84.

Formation at the blunt end 50, shown in FIGS. 1 and 9, 10 and 11, may be by cutting and bending means of the blunt end 50 at a blunt end first side 51 and or a blunt end second side 52 either from the blunt end first side 51 and/or blunt end second side 52 most distal from a blunt end midpoint 53 to a point intermediate the blunt end first side 51 and/or blunt end second side 52 and the midpoint 53 to form at least one tip tab 50′ downwardly extending from the blunt end 50 and extending orthogonal to the post 10 to be received into a slit 100 formed in a spacing means 84.

An alternative formation of at least one downwardly extending tip tab 50′ at the blunt end 50 is by cutting and bending means of the blunt end 50 at a blunt end first side 51 and or a blunt end second side 52 from the blunt end midpoint 53 to a point intermediate the blunt end midpoint 53 and the point most distal the blunt end midpoint 53 and either the blunt end first side 51 and/or blunt end second side 52 to form at least one tip tab 50′ downwardly extending from the blunt end 50 and extending orthogonal to and toward the post 10 to be received into a slit 100 formed in a spacing means 84.

Thus the formation of at least one downwardly extending tip tab 50′ orthogonal to and extending toward the post 10 in the offset 30 or at the blunt end 50 will provide the necessary structure. Where the at least one tip tab 50′ is formed at the offset 30 the tip alternative 42 will terminate the structure of the muntin bar clip 1. Hence, in the formation of the at least one tip tab 50′ at the offset 30 the tip alternative 42 will terminate as the tip alternative 42 point as shown in FIG. 1A.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

I claim:

1. A muntin bar clip with tip tab comprising:
a) at least one post 10, a tip 40 having a tip end 43 distal from a post end 13; an offset 30 formed intermediate the tip 40 and the fastener means 20; the offset having a first side 31, a second side 32 and an offset midpoint 33;
b) a downwardly projecting blunt end 50 at the tip end 43; the blunt end 50 having a blunt end first side 51, a blunt end second side 52 and a blunt end midpoint 53 intermediate the said blunt end first side 51 and blunt end second side 52;
c) the blunt end 50 proximal the blunt end first side 51 and or proximal the blunt end second side 52, is bent, by metal forming means, to form at least one tip tab 50′ orthoronal to the offset 30, projecting toward the post 10 and projecting downwardly from the offset 30 to be received into a slit 100 in a spacing means.

2. A muntin bar clip according to claim 1 wherein:
a) the blunt end 50 proximal the blunt end first side 51 and or proximal the blunt end second side 52, cut and bent, by metal forming means, to form at least one tip tab 50′ intermediate the blunt end first side 51 and the blunt end second side 52 such that the at least one tip tab 50′ is orthogonal to the offset 30 and projecting toward the post 10.

3. A muntin bar clip according to claim 1 wherein:
a) one or a plurality of spikes 44 are formed in the blunt end 50 which are generally parallel to the offset 30 and project toward a plane of the tip second end 43.

4. A muntin bar clip according to claim 2 wherein:
a) one or a plurality of spikes 44 are formed in the blunt end 50 which are generally parallel to the offset 30 and project toward a plane of the tip second end 43.

5. A muntin bar clip according to claim 1 wherein:
a) each of the at least one tip tab 50′ is received into at least one ink marked 150 slit 100 in a spacing means.

6. A muntin bar clip according to claim 2 wherein:
a) the at least one tip tab 50′ received into an ink marked 150 slit 100 in a spacing means.

7. A muntin bar clip with tip tab comprising:
a) at least one post 10, a tip 40 having a tip end 43 distal from a post end 13; an offset 30 formed intermediate the tip 40 and the fastener means 20; the offset having a first side 31, a second side 32 and an offset midpoint 33;
b) the first side 31 and or the second side 32 is bent downwardly proximal the mid point 33, forming at least one offset tip tab 30′ and or 30″ orthogonal to a spacing means 84 and received into an ink marked 150 slit 100 formed in the spacing means 84.

8. A muntin bar clip according to claim 5 wherein:
a) the at least ink marked 150 slit 100 is formed by spacing means application means which indexes and cuts or slits 100 the spacing means 84 as required for the installation of muntin bars and muntin bar clips having at least one tip tab 50′; the ink marking 150 of the slit 100 is by a dot or line of printer ink 150 applied by the addition of a cartridge receptacle means receiving a printer head 200 where said printer head 200 is controlled by printer computer program means 190 received into a computer 192 or controller having memory 194 wherein said printer computer program means 190 causes a printer control unit 196 to actuate a printer head drive unit means 198 causing printer head 200 to apply a line or dot of printer ink 150 as the spacing means application means indexes to the location in the spacing means 84 where a slit 100 is formed in the spacing means 84 by the spacing means application means.
